(19) United States
(12) Patent Application Publication
(10) Pub. No.: US 2025/0103304 A1
(43) Pub. Date: Mar. 27, 2025

(54) PROFILE-BASED KNOWLEDGE EMBEDDING FOR AI-ASSISTED DEVELOPMENT

(71) Applicant: SAP SE, Walldorf (DE)

(72) Inventors: XIN YE, Beijing (CN); Zhi-feng Deng, Beijing (CN); Lei Huang, Beijing (CN); Wei-quan Zhou, Beijing (CN)

(21) Appl. No.: 18/371,281

(22) Filed: Sep. 21, 2023

(51) Int. Cl. G06F 8/33

(52) U.S. Cl. CPC G06F 8/33

(57) ABSTRACT

Embodiments are described for a code generating system comprising a memory and at least one processor coupled to the memory. The at least one processor is configured to receive an instruction to generate a source code and retrieve the code profile from a profile manager. The instruction include a user description and information of a code profile. The at least one processor is further configured to generate a first command by combining the user description and the code profile and transmit the first command to an artificial intelligence (AI) proxy. Finally, the at least one processor is configured to receive the source code from the AI proxy and transmit the source code to a user device.

### BACKGROUND

Artificial intelligent (AI) assistant tools may be used for various tasks. One example is AI-assisted source code generation (AIGC). Specifically, software development can include repetitive coding tasks that may be time-consuming and error-prone. Thus, using the AI assistant tools to generate source codes to automate the repetitive coding tasks is promising. However, it can be challenging to produce source codes efficiently and accurately using the AI assistant tools.

### SUMMARY

Some embodiments of this disclosure relate to apparatus, system, computer program product, and method embodiments for implementing profile-based AI assisted code generation.

Some embodiments of this disclosure provide a code generating system comprising a memory and at least one processor coupled to the memory. The at least one processor is configured to receive an instruction to generate a source code and retrieve the code profile from a profile manager. The instruction includes a user description and information of a code profile. The at least one processor is further configured to generate a first command by combining the user description and the code profile and transmit the first command to an artificial intelligence (AI) proxy. Finally, the at least one processor is configured to receive the source code from the AI proxy and transmit the source code to a user device.

Some embodiments of this disclosure provide a computer-implemented method for a code generating system. The method comprises receiving an instruction to generate a source code and retrieving the code profile from a profile manager. The instruction includes a user description and information of a code profile. The method further comprises generating a first command by combining the user description and the code profile and transmitting the first command to an artificial intelligence (AI) proxy. Finally, the method comprises receiving the source code from the AI proxy and transmitting the source code to a user device.

Some embodiments of this disclosure provide a non-transitory computer-readable medium (CRM) comprising instructions to, when executed by at least one computing device, causes the at least one computing device to perform operations. The operations comprise receiving an instruction to generate a source code and retrieving the code profile from a profile manager. The instruction includes a user description and information of a code profile. The operations further comprise generating a first command by combining the user description and the code profile and transmitting the first command to an artificial intelligence (AI) proxy. Finally, the operations comprise receiving the source code from the AI proxy and transmitting the source code to a user device.

This Summary is provided merely for the purposes of illustrating some embodiments to provide an understanding of the subject matter described herein. Accordingly, the above-described features are merely examples and should not be construed to narrow the scope or spirit of the subject matter in this disclosure. Other features, embodiments, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing profile-based AI assisted code generation, according to some embodiments of the disclosure.

FIG. 2 illustrates a block diagram of an example system implementing the profile-based AI assisted code generation, according to some embodiments of the disclosure.

FIG. 3 illustrates an example method of generating source codes using AI assistants, according to some embodiments of the disclosure.

FIG. 4 illustrates an example of an interactive user interface, according to some embodiments of the disclosure.

FIG. 5 is an example computer system for implementing some embodiments of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some embodiments of this disclosure include apparatus, system, computer program product, and method embodiments for implementing profile-based AI assisted code generation.

In recent years, AI assistant tools, such as ChatGPT, Bard, GitHub, and others, have been developed and made available to the public. In some embodiments, the AI assistant tools, including the ChatGPT, can be based on a large language model (LLM) and can be used to complete various tasks. For example, the AI assistant tools can be used to generate source codes. In some embodiments, a user, such as a computer programmer or a developer, can instruct the AI assistant tools to realize one or more features using source codes. For example, the user can describe the one or more features using natural language in a user description and send the user description to the AI assistant tools. The AI assistant tools can then generate the source codes based on the user description. However, this approach can face several issues.

In some embodiments, the AI assistant tools may lack necessary side information, such as context, domain knowledge, requirements, and other information of the source codes that the user wants. Thus, results provided by the AI assistant tools can be inaccurate or even incorrect. For example, the source codes may be used for an application logic, a unit test, or other purposes. Without the side information that indicates a purpose of the source codes, the AI assistant tools may generate source codes that are not usable by the user. For another example, source codes may have different styles or formats for different scenarios. Specifically, the user may prefer or be required to use certain predefined functions in given situations. Without providing the side information that indicates these requirements, the AI assistant tools may generate source codes that do not include the predefined functions. Thus, the source code may be functional, but not accurate. In such a case, the user may need to manually edit the source codes or rewrite an entire section of the source codes. This can be time-consuming and may defeat the purpose of AIGC.

In some embodiments, the user may include the side information in the user description sent to the AI assistant tools. However, such an approach can be impractical for at least two reasons. First, a user description that includes the side information can be complicated and lengthy. Thus, it can be time-consuming and error-prone for the user to generate the user description in the first place. In an extreme case, when the side information is complicated and specific, generating the user description may be more time-consuming and complicated than writing the source codes directly. In such a case, it may be more efficient and reliable to generate the source codes without using the AI assistant tools. Second, the user may not be familiar with the side information, including the requirements, and thus may not be able to generate the user description properly to include the side information. For example, as discussed above, the requirements may involve specific predefined functions to be used in the source code. The user may not be familiar with the predefined functions and thus may not be able to provide the side information as such.

In some embodiments, the user can interact with the AI assistant tools via a code generating system. For example, the code generating system can provide a code profile that includes the side information to be used to generate the source codes. In some embodiments, the source codes may be directed to application logic that includes one or more predefined functions. The code generating system can provide a first code profile that indicates the application logic and the one or more predefined functions. In such a case, the user can also select the first code profile in the code generating system or a profile manager to indicate the side information. The user can also generate a user description indicating desired features to be realized and send the user description to the code generating system. The code generating system can then combine the user description and the first code profile into a command and send it to the AI assistant tools. In this way, the user provides the necessary context, domain knowledge, and other information by selecting the first code profile in the code generating system, instead of manually writing them out. In some embodiments, after receiving the command, the AI assistant tools can generate source codes based on the command and send the source codes to the code generating system. The code generating system can then forward the source codes to the user.

In some embodiments, the user may review the source codes received from the code generating system. The user may accept or update the source codes. For example, the user may determine that the source codes function properly and meet requirements. In such a case, the user can accept the source codes. For another example, the user may determine that the source codes are inaccurate and need to be updated. The user can generate an updated user description and send it to the code generating system. The user may also select a second code profile that is different from the first code profile based on the source codes received. The code generating system then combines the updated user description with the second code profile, if selected, to generate a second command. After that, the code generating system can send the second command to the AI assistant tools to generate updated source codes to be sent to the user. The user can review the updated source codes. This process can be repeated until the user accepts the updated source codes. In this way, the source code generated by the AI assistant tools can be improved over iterations.

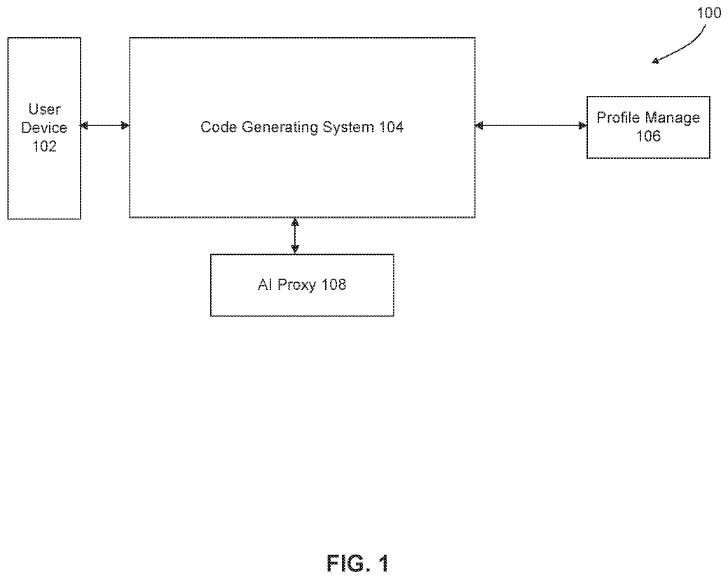

FIG. 1 illustrates an example system implementing profile-based AI assisted code generation, according to some embodiments of the disclosure. The example system 100 is provided for the purpose of illustration only and does not limit the disclosed embodiments. The example system 100 may include, but is not limited to, a user device 102, a code generating system 104, a profile manager 106, and an AI proxy 108. The user device 102 may include, but is not limited to, wireless communication devices, smartphones, laptops, desktops, tablets, personal assistants, monitors, televisions, wearable devices, Internet of Things (IoT) devices, vehicle communication devices, and the like. The code generating system 104 may include, but is not limited to, computer systems, servers, cloud systems, cloud servers, laptops, desktops, personal computers, and the like. The profile manager 106 can be a local storage device or a remote storage system operating through the cloud. In some embodiments, the profile manager 106 can be integrated into the code generating system 104. The AI proxy 108 can be a server that connects with AI assistant tools, such as ChatGPT, Bard, GitHub, and so on.

In some embodiments, a user, such as a computer programmer or a developer, may want to generate source codes to realize one or more features using the AI assistant tools supported by the AI proxy 108. For example, the user may want to generate the source codes of an application logic using the ChatGPT or GPT. The user can generate, using the user device 102, a user description that indicates the one or more features. The user description can be written in a natural language instead of a computer language. In some embodiments, the user can transmit the user description to the code generating system 104 using the user device 102. For example, the user can type the user description into the user device 102 and configure the user device 102 to transmit the user description to the code generating system 104. In some embodiments, the user can also choose a code profile corresponding to the source codes. As discussed above, the user may want the source codes to be generated based on certain context and domain knowledge. In addition, the user may also want the source codes to have certain formats and/or include one or more predefined functions. To achieve these requirements, the user can choose a code profile that indicates such requirements to the source codes so that the AI assistant tools can generate the source codes based on the requirements. For example, the profile manager 106 may include one or more code profiles, each indicating one or more requirements to source codes, such as context, domain knowledge, format requirements, functions requirements, and so on as discussed herein. The user can select a first code profile out of the one or more code profiles to be considered when generating the source code. Specifically, the user can transmit information of the first code profile to the code generating system 104 using the user device 102. The information of the first code profile can be an index or an identifier of the first code profile. In some embodiments, the user device 102 can combine the user description and the information of the first code profile into an instruction and transmit the instruction to the code generating system 104. It is worth noting that the profile manager 106 and/or the code generating system 104 can provide a list of the one or more code profiles to the user device 102. In such a case, the user can select from the one or more code profiles.

In some embodiments, when the code generating system 104 receives the instruction, it can retrieve the first code profile from the profile manager 106. For example, the code generating system 104 can transmit a request that indicates the first code profile to the profile manager 106. The profile manager 106 can then transmit the first code profile to the code generating system 104. In some embodiments, the profile manager 106 may be integrated into the code generating system 104. In such a case, the code generating system 104 can retrieve the first code profile locally from the profile manager 106.

In some embodiments, once the first code profile is retrieved, either via the request or locally, the code generating system 104 can combine the user description received from the user device and the first code profile into a first command. The code generating system 104 can then transmit the first command to the AI proxy 108. The AI proxy 108 then executes the command using an AI assistant tool, such as GPT, and retrieves a result, e.g., the source code from the AI assistant tool. The AI proxy 108 can then transmit the source codes to the code generating system 104, which forwards the source codes to the user device 102.

In some embodiments, the user can receive the source codes and determine whether to accept the source codes. For example, the user can determine that the source codes are functional and accurate. In such a case, the user can accept the source codes. For another example, the user can determine that the sources are not functional and/or inaccurate. Thus, the user can generate and transmit an updated user description to the code generating system 104 using the user device 102 to update the source code.

In some embodiments, the user can interact with the code generating system 104 directly. For example, the code generating system 104 may include a user interface where the user can enter the user description. The user interface may also enable the user to select a code profile from one or more code profiles. For example, the user interface may display the list of code profiles and the user can select from the list.

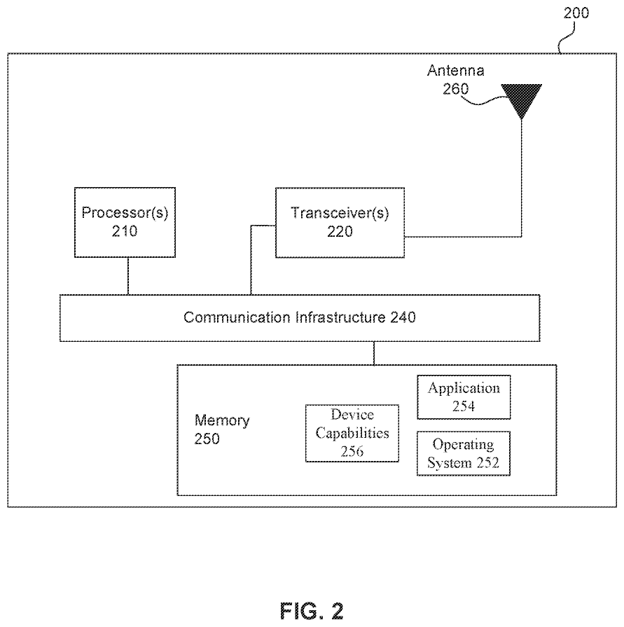

FIG. 2 illustrates a block diagram of an electronic device 200 implementing the profile-based AI assisted code generation, according to some embodiments of the disclosure. The electronic device 200 may be any of the electronic devices (e.g., the user device 102, the code generating system 104, the profile manager 106, the AI proxy 108, or a combination thereof of FIG. 1) of the system 100. The electronic device 200 includes a processor 210, one or more transceivers 220, a communication infrastructure 240, a memory 250, an operating system 252, an application 254, device capabilities 256, and antenna 260. Illustrated systems are provided as exemplary parts of electronic device 200, and electronic device 200 may include other circuit(s) and subsystem(s). Also, although the systems of electronic device 200 are illustrated as separate components, the embodiments of this disclosure may include any combination of these, e.g., less, or more components.

The memory 250 may include random access memory (RAM) and/or cache, and may include control logic (e.g., computer software) and/or data. The memory 250 may include other storage devices or memory. According to some examples, the operating system 252 may be stored in the memory 250. The operating system 252 may manage transfer of data from the memory 250 and/or the one or more applications 254 to the processor 210 and/or the one or more transceivers 220. In some examples, the operating system 252 maintains one or more network protocol stacks (e.g., Internet protocol stack, cellular protocol stack, and the like) that may include a number of logical layers. At corresponding layers of the protocol stack, the operating system 252 includes control mechanisms and data structures to perform the functions associated with that layer.

According to some examples, the application 254 may be stored in the memory 250. The application 254 may include applications (e.g., user applications) used by the electronic device 200 and/or a user of the electronic device 200. The application 254 may include functions such as, but not limited to, radio streaming, video streaming, remote control, and/or other user functions. In some embodiments, the device capabilities 256 may be stored in the memory 250.

The electronic device 200 may also include the communication infrastructure 240. The communication infrastructure 240 provides communication between, for example, the processor 210, the one or more transceivers 220, and the memory 250. In some implementations, the communication infrastructure 240 may be a bus.

The processor 210, alone, or together with instructions stored in the memory 250 performs operations enabling electronic device 200 of the system 100 to implement mechanisms for the profile-based AI assisted code generation, as described herein. Alternatively, or additionally, the processor 210 can be “hard coded” to implement mechanisms for the profile-based AI assisted code generation, as described herein.

The one or more transceivers 220 transmit and receive communications signals support mechanisms for the profile-based AI assisted code generation. Additionally, the one or more transceivers 220 transmit and receive communications signals that support mechanisms for measuring communication link(s), generating and transmitting system information, and receiving the system information. According to some embodiments, the one or more transceivers 220 may be coupled to the antenna 260 to wirelessly transmit and receive the communication signals. The antenna 260 may include one or more antennas that may be the same or different types and can form one or more antenna ports. The one or more transceivers 220 allow electronic device 200 to communicate with other devices that may be wired and/or wireless. In some examples, the one or more transceivers 220 may include processors, controllers, radios, sockets, plugs, buffers, and like circuits/devices used for connecting to and communication on networks. According to some examples, the one or more transceivers 220 include one or more circuits to connect to and communicate on wired and/or wireless networks.

According to some embodiments of this disclosure, the one or more transceivers 220 may include a cellular subsystem, a WLAN subsystem, and/or a Bluetooth™ subsystem, each including its own radio transceiver and protocol(s) as will be understood by those skilled in the arts based on the discussion provided herein. In some implementations, the one or more transceivers 220 may include more or fewer systems for communicating with other devices.

In some examples, the one or more the transceivers 220 may include one or more circuits (including a WLAN transceiver) to enable connection(s) and communication over WLAN networks such as, but not limited to, networks based on standards described in IEEE 802.11.

Additionally, or alternatively, the one or more the transceivers 220 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the transceiver 220 may include a Bluetooth™ transceiver. Additionally, the one or more the transceivers 220 may include one or more circuits (including a cellular transceiver) for connecting to and communicating on cellular networks.

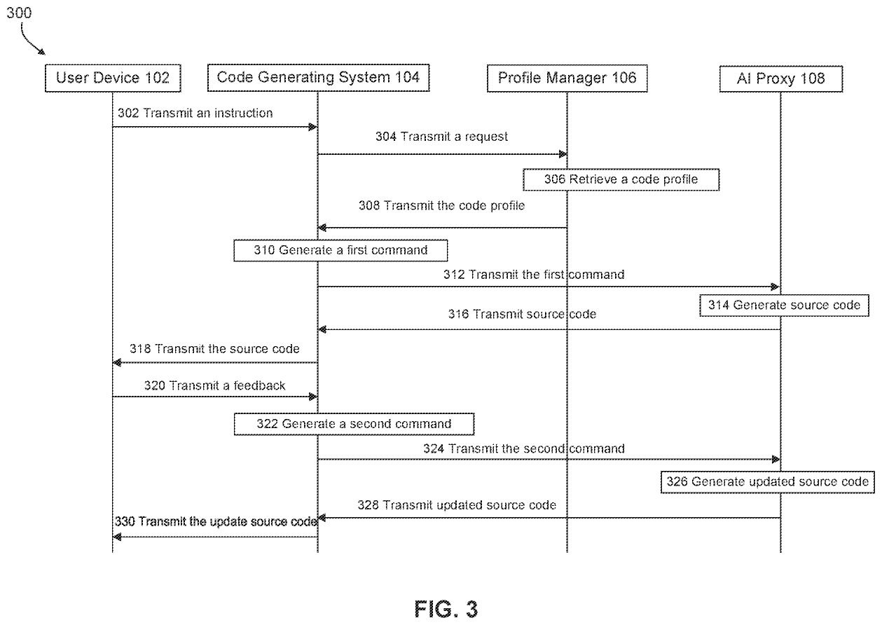

As discussed in more detail below with respect to FIGS. 3-5, processor 210 may implement different mechanisms for retrieving, processing, and displaying data as discussed with respect to the system 100 of FIG. 1.

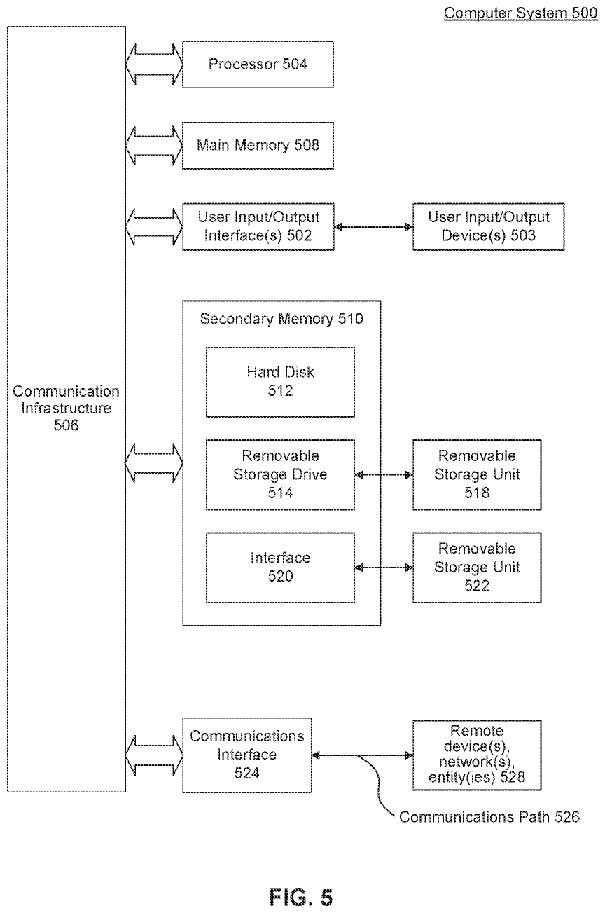

FIG. 3 illustrates an example method 300 of generating source codes using AI assistants, according to some embodiments of the disclosure. As a convenience and not a limitation, FIG. 3 may be described with regard to elements of FIGS. 1, 2, and 5. The example method 300 may represent the operation of devices (e.g., the user device 102, the code generating system 104, the profile manager 106, the AI proxy 108, or a combination thereof of FIG. 1) implementing generating source codes using AI assistants. The example method 300 may also be performed by computer system 500 of FIG. 5. But the example method 300 is not limited to the specific embodiments depicted in those figures and other systems may be used to perform the method, as will be understood by those skilled in the art. It is to be appreciated that not all operations may be needed, and the operations may not be performed in the same order as shown in FIG. 3.

At 302, the user device 102 transmits an instruction to generate source codes to the code generating system 104. In some embodiments, the instruction can include a user description and information of a code profile. For example, a user may want to generate source codes to realize one or more features. The user device 102 may generate the user description that indicates the one or more features. Furthermore, the source code may be subject to certain requirements. Specifically, the user may want the source codes to be based on certain context and domain knowledge. In addition, the source codes may be subject to one or more format restrictions. In some embodiments, the requirements can be included in a code profile out of one or more code profiles stored in the profile manager 106. The user may select a first code profile using the user device 102. The user device 102 can then combine the user description and the information of the first code profile into the instruction and transmit the instruction to the code generating system 104.

In some embodiments, the first code profile can be selected automatically without a specific user input. For example, the user device 102 and/or the code generating system 104 may determine the first code profile. Specifically, the user may operate an application logic editor when generating the user description. In some embodiments, the application logic editor may be provided by the user device 102. Thus, the user device 102 can determine that the user uses the application logic editor to generate the user description and the first code profile can correspond to application logic. In such a case, the user device 102 can select the first code profile and generate the instruction based on the first code profile. In some embodiments, the code generating device 104 can determine, via the user device 102, that the user uses the application logic editor to generate the user description and thus select the first code profile. In such a case, the instruction may not need to include the information of the first code profile. It is worth noting that the user may operate other editors when generating the user description and the user device 102 and/or the code generating system 104 can determine a code profile using other information. For example, the user may operate a mock data editor and thus the user device 102 and/or the code generating system 104 may determine a second code profile corresponding to mock data.

At 304, the code generating system 104 can transmit a request to the profile manager 106. In some embodiments, the code generating system 104 can retrieve the information of the first code profile from the instruction received from the user device 102. The information of the first code profile may include or indicate an index and/or an identifier of the first code profile. In such a case, the request may include the information of the first code profile or the index and/or the identifier of the first code profile.

At 306, upon receiving the request, the profile manager 106 can retrieve the first code profile based on the request from a memory of the profile manager 106. For example, the request may indicate or include the index and/or the identifier of the first code profile and the profile manager 106 can retrieve the first code profile based on the index and/or the identifier of the first code profile. In some embodiments, the index and/or the identifier of the first code profile distinguishes the first code profile from other code profiles stored in the profile manager 106.

In some embodiments, the profile manager 106 can include one or more code profiles. Each of the code profile can indicate information of source codes, such as context, domain knowledge, requirements, and/or other properties of the source codes. Furthermore, different code profiles correspond to different source codes. For example, the first code profile may correspond to the source codes of an application logic that realizes a first set of features using a first set of functions. A second code profile may correspond to source codes of a unit test that realizes a second set of features using a second set of functions.

In some embodiments, the profile manager 106 can generate the one or more code profiles. For example, the profile manager 106 can generate a code profile for each combination of characteristics of source codes, such as context, domain knowledge, requirements, and/or other properties of the source codes. For another example, the profile manager 106 can also generate code profiles corresponding to combinations of characteristics of source codes that were previously generated by the AI assistant tools. Specifically, the user device 102 may have previously generated an input to be sent to the AI proxy 108 for generating source codes, wherein the input includes a first combination of characteristics including the context, the domain knowledge, the requirements, and/or other properties of the source codes. The user device 102 and/or the AI proxy 108 may transmit the input to the profile manager 106. In such a case, the profile manager 106 can generate a code profile, such as the first code profile, based on the input. Thus, when the user wants to generate source codes corresponding to the first combination of characteristics again, the user or the user device 102 can select the first code profile without generating the input from scratch. In some embodiments, the profile manager 106 can receive one or more code profiles from other devices. For example, developers can generate one or more code profiles and transmit the one or more code profiles to the profile manager 106 using their user devices.

In some embodiments, a code profile may include one or more sections. For example, a code profile, such as the first code profile, may include three sections: a name section, a description section, and a knowledge section. The name section includes a name of project. For example, the first code profile may correspond to projects of application logic. In such a case, the name of project can be “Application Logic.” If the first code profile corresponds to projects of service unit testing, the name of the project can be “Service Direct Testing.” The description section can include a summary of corresponding projects. For example, for application logic projects, the summary can include “imagine that you are a helpful assistant who can generate application logic (a.k.a., event handler) for a CAP project.” For the service unit testing projects, the summary can include “imagine that you are a helpful assistant who can generate Node.js unit test for a running CAP service.” It is worth noting that the summary included in the description section can be different from the user description included in the instruction transmitted by the user device 102 and received by the code generating system 104 at 302.

Finally, the knowledge section may include at least three types of messages: instruction, restriction, and requirement. It is worth noting that the instruction messages included in the first code profile can be different from the instruction transmitted by the user device 102 and received by the code generating system 104 at 302. In some embodiments, the instruction messages may include implementation instructions for the code generation. For example, the instruction messages can indicate one or more sections of existing source codes. Specifically, if the first code profile corresponds to projects of application logic, the instruction messages may include “please implement the function to address the feature specification within the function JSDoc section.” If the first code profile corresponds to projects of unit testing, the instruction message may include “please implement the unit test for the application logic function, which is the entity's event handler of the CAP service.” In some embodiments, the instruction messages may include one or more coding languages. For example, the instruction messages may indicate that the source codes are to be generated in JavaScript, C++, JAVA, and/or any other programming languages. In some embodiments, the instruction messages may include one or more predefined functions to be used in the source codes. For example, the instruction message may include “please use the CAP testing framework provided uppercase bound functions like GET, POST, PUT, and/or DELETE.”

In some embodiments, the restriction messages may also include one or more predefined functions to be used in the source codes. For example, the restriction message may include “please use CAP COL functions, such as SELECT, UPDATE, INSERT, and/or DELETE, for the service entity manipulation.” In some embodiments, the restriction messages may include explanations of functions and/or variables of existing source codes. For example, the restriction messages can include “the function argument ‘context’ is the wrapper object of the arguments of CAP event handler.” For another example, the restriction message may include “the custom JSDoc tag, e.g., ‘@Before,’ ‘@On,’ or ‘@After,’ is used to describe the CAP event phase.” For yet another example, the restriction message may include “the OData URI path in the entity manipulation function is defined in the @path annotation in ‘service.cds’ filed.” In some embodiments, the restriction message may include one or more implementation goals. For example, the restriction message may include “the testing target is against a running service which is defined from the CAP model files.” For another example, the restriction message may include “the testing purpose is to verify the application logic function.”

In some embodiments, the requirement messages may include one or more illustration requirements. For example, the requirement messages may include “please show the result in the form of ${service0name service-entity-name}-${phase-name}-${event-name} js\n.” For another example, the requirement message may include “please show the result in the provided serviceTesting content.”

In some embodiments, the first code profile may also include domain knowledge and context of the source codes. The domain knowledge includes information on a specific field of technology or industry. For example, in the wireless communication filed, the domain knowledge may include technical expertise, such as theories and methods of generating and processing wireless signals. The domain knowledge may also include regulatory information. Again in the wireless communication field, the regulatory information may include maximum transmission power in one or more frequencies. In some embodiments, the context of the source code may include environment, conditions, and/or state in which the source codes are executed. For example, the context may include definitions of one or more predefined functions used in the source codes. The context may also include definitions of one or more local variables and/or global variables. In some embodiments, the profile manager 106 or the code generating system 104 can extract the context of the source codes from a runtime environment or an integrated development environment (IDE). The runtime environment or the IDE may include information of libraries, application program interfaces (APIs), input/output (I/O) operations, a working directory, and other information regarding executing the source codes. The runtime environment or the IDE can be stored locally in the code generating system 104 or remotely in other devices, such as the user device 102.

At 308, the profile manager 106 transmits the first code profile to the code generating system 104.

At 310, the code generating system 104 generates a first command based on the user description and the first code profile. For example, the code generating system 104 can combine the user description and the first code profile to generate the first command. In some embodiments, the code generating system 104 can concatenate the first code profile with the user description.

At 312, the code generating system 104 transmits the first command to the AI proxy 108. As discussed above, the AI proxy 108 may connect with one or more AI assistant tools or integrate with the one or more AI assistant tools.

At 314, the AI proxy 108 can generate the source codes using the one or more AI assistant tools based on the first command. The first command can be an input to the one or more AI assistant tools and the source codes can be an output from the one or more AI assistant tools.

At 316, the AI proxy 108 can transmit the source codes to the code generating system 104.

At 318, the code generating system 104 can transmit the source codes to the user device 102. In some embodiments, the user device 102 may review the source codes and determine whether to accept the source codes. For example, the user device 102 may try to execute the source codes. If the source codes execute successfully, the user device 102 may further review results of the execution. If the results are correct and accurate, the user device 102 may accept the source codes. In such a case, the user device 102 may store the source codes for further development. The user device 102 may also transmit a confirmation message to the code generating system 104 indicating that the source codes were accepted. In some embodiments, the user device 102 may also check the source codes to see if the source codes meet requirements of the first code profile. For example, the first code profile may include one or more predefined functions. If the source codes do not include the one or more predefined functions, the user device 102 may determine to not accept the source codes even when the results are correct and accurate. Otherwise, if the source codes include the one or more predefined functions and the results are correct and accurate, the user device 102 may determine to accept the source codes.

In some embodiments, the user device 102 may determine to not accept the source codes, for example, when the source codes cannot be executed, produce incorrect or inaccurate results, or do not conform to the first code profile. In such a case, the user device 102 can update the source codes by transmitting a feedback as discussed further at 320. The user device 102 may also determine to cancel the code generating process. For example, the source codes may be not executable and not practical to fix. Specifically, the execution of the source codes may return a number of errors and the number is higher than a predetermined value. In such a case, the user device 102 may determine that it takes more time to clear the errors than starting over from scratch. Thus, the user device 102 may restart the process from the step 302 by generating a new instruction. For example, the user device 102 may generate a new user description and/or select a different code profile.

At 320, the user device 102 transmits the feedback to the code generating system 104. The feedback can include an updated user description. The user device 102 may adjust the one or more features to be realized by the source codes. For example, the user device 102 can remove a feature in the updated user description or add an additional feature to the updated user description. Specifically, the user device 102 may determine that a feature of the one or more features is not compatible with other features of the one or more features. The user device 102 may also determine that the additional feature is needed to realize the one or more features. For another example, the user device 102 may update user descriptions to the one or more features. Specifically, the user device 102 may determine that the source codes do not realize the one or more features accurately because the descriptions of the one or more features are not accurate. In such a case, the user device 102 can update the descriptions to better capture the one or more features. In some embodiments, the feedback can also include information of a second code profile. For example, the user device 102 may determine that the first code profile is not suitable for realizing the one or more features and the second code profile is a better option.

At 322, the code generating system 104 can generate a second command. For example, the feedback may include the updated user description and information of the second code profile. In such a case, the code generating system 104 can generate the second command by combining the updated user description and the second code profile. The code generating system 104 can retrieve the second code profile from the profile manager 106 as similarly discussed in steps 304, 306, and 308. In some embodiments, the code generating system 104 can further add the first command to the second command. Thus, the second command may include the first command, which includes the user description and the first code profile, the updated user description, and the second code profile if indicated in the feedback.

At 324, the code generating system 104 transmits the second command to the AI proxy 108, which inputs the second command into the one or more AI assistant tools.

At 326, the AI proxy 108 generates updated source code using the one or more AI assistant tools based on the second command.

At 328, the AI proxy 108 transmits the updated source codes to the code generating system 104, which forwards the updated source codes to the user device 102 at 330. The user device 102 can then determine whether to accept the updated source codes. If the user device 102 determines to accept the updated source codes, the operation ends. Otherwise, if the user device 102 determines to further update the source codes, the operation moves back to 320 and the user device 102 can generate an additional feedback. The user device 102 can also start over from the step 302 if the user device 102 determines that the update source codes are impractical to fix as discussed above.

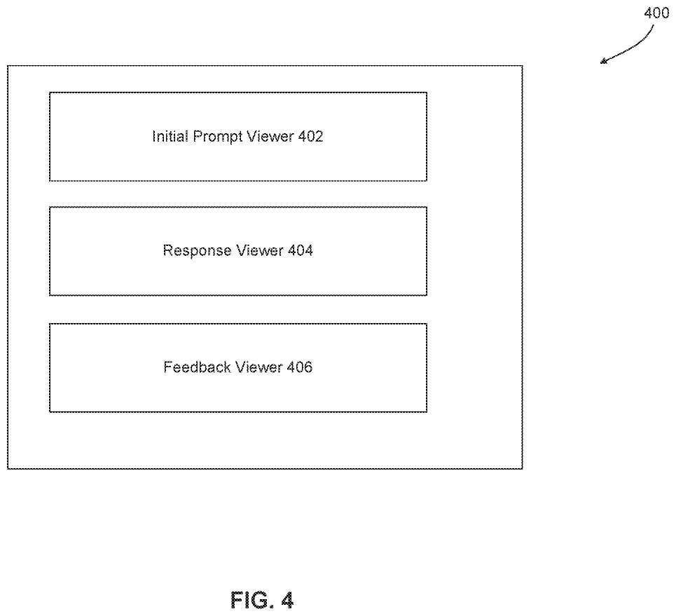

FIG. 4 illustrates an example 400 of an interactive user interface, according to some embodiments of the disclosure. As a convenience and not a limitation, FIG. 4 may be described with regard to elements of FIGS. 1, 2, and 5. The example 400 may represent the operation of devices (e.g., the user device 102, the code generating system 104, the profile manager 106, the AI proxy 108, or a combination thereof of FIG. 1) implementing the interactive user interface. The example 400 may also be performed by computer system 500 of FIG. 5. But the example 400 is not limited to the specific embodiments depicted in those figures and other systems may be used to perform the method, as will be understood by those skilled in the art. It is to be appreciated that not all operations may be needed, and the operations may not be performed in the same order as shown in FIG. 4.

In some embodiments, the interactive user interface can include one or more viewer sections. For example, the example 400 includes an initial prompt viewer section 402, a response viewer section 404, and a feedback viewer section 406. In the initial prompt reviewer section 402, a user can enter a user description of source codes to be generated. In some embodiments, the initial prompt reviewer section 402 can also display content of a code profile, such as the first code profile. In such a case, the initial prompt reviewer section 402 can display context, domain knowledge, and other requirements of the source codes. The response viewer section 404 includes responses generated by the AI proxy 108. For example, the responses can include the source codes generated by the AI proxy 108 and sent to the user device 102 at 318 and 330 in FIG. 3. In some embodiments, the response viewer section 404 can also illustrate results rendered by the source codes. For example, the user device 102 can execute the source codes received and illustrate the results in the response viewer section 404. In some embodiments, the response viewer section 404 can also include a response action subsection. The user can select to accept, update, or discard the source code in the response action subsection. As discussed above, the user device 102 can accept the source codes if the source codes execute successfully and produce correct and accurate results. The user device 102 can also update the source codes by providing a feedback as discussed in step 320 of FIG. 3. Finally, the user device 102 can discard the source codes and start over from the step 302 of the FIG. 3. The feedback reviewer section 406 may include a feedback transmitted from the user device 102 to the code generating system 104 as discussed in the step 320 of FIG. 3. In addition, the feedback reviewer section 406 may also illustrate error messages produced by the source codes, such as runtime errors.

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A code generating system, comprising:
a memory; and
at least one processor coupled to the memory and configured to;
receive an instruction to generate a source code, wherein the instruction includes a user description and information of a code profile;
retrieve the code profile from a profile manager;
generate a first command by combining the user description and the code profile;
transmit the first command to an artificial intelligence (AI) proxy;
receive the source code from the AI proxy; and
transmit the source code to a user device.

2. The code generating system of claim 1, wherein to retrieve the code profile, the at least one processor is further configured to:
retrieve an identifier of the code profile from the information of the code profile, wherein the identifier of the code profile distinguishes the code profile from other code profiles in the profile manager;
transmit a request for the code profile to the profile manager, wherein the request includes the identifier of the code profile; and
receive the code profile from the profile manager.

3. The code generating system of claim 1, wherein the code profile comprises:
one or more coding languages indications,
one or more existing source code sections,
one or more functions to be used in the source code, or
one or more illustration requirements.

4. The code generating system of claim 1, wherein the user description comprises one or more features to be realized by the source code, and wherein the user description is a natural language description.

5. The code generating system of claim 1, wherein the code profile comprises domain knowledge and context of the source code.

6. The code generating system of claim 5, wherein the at least one processor is further configured to extract the context from a runtime environment.

7. The code generating system of claim 1, wherein the at least one processor is further configured to:
receive a feedback from the user device, wherein the feedback includes an updated user description;
generate a second command by combining the updated user description and the first command;
transmit the second command to the AI proxy;
receive an updated source code; and
transmit the updated source code to the user device.

8. A computer-implemented method for a code generating system, comprising:
receiving an instruction to generate a source code, wherein the instruction includes a user description and information of a code profile;
retrieving the code profile from a profile manager;
generating a first command by combining the user description and the code profile;
transmitting the first command to an artificial intelligence (AI) proxy;
receiving the source code from the AI proxy; and
transmitting the source code to a user device.

9. The computer-implemented method of claim 8, wherein retrieving the code profile from the profile manager further comprises:
retrieving an identifier of the code profile from the information of the code profile, wherein the identifier of the code profile distinguishes the code profile from other code profiles in the profile manager;
transmitting a request for the code profile to the profile manager, wherein the request includes the identifier of the code profile; and
receiving the code profile from the profile manager.

10. The computer-implemented method of claim 8, wherein the code profile comprises:
one or more coding languages indications,
one or more existing source code sections,
one or more functions to be used in the source code, or
one or more illustration requirements.

11. The computer-implemented method of claim 8, wherein the user description comprises one or more features to be realized by the source code, and wherein the user description is a natural language description.

12. The computer-implemented method of claim 8, wherein the code profile comprises domain knowledge and context of the source code.

13. The computer-implemented method of claim 12, further comprising extracting the context from a runtime environment.

14. The computer-implemented method of claim 8, further comprising:
receiving a feedback from the user device, wherein the feedback includes an updated user description;
generating a second command by combining the updated user description and the first command;
transmitting the second command to the AI proxy;
receiving an updated source code; and
transmitting the updated source code to the user device.

15. A non-transitory computer-readable device having instructions stored thereon that, when executed by at least one computing device, cause the at least one computing device to perform operations, the operations comprising:
receiving an instruction to generate a source code, wherein the instruction includes a user description and information of a code profile;
retrieving the code profile from a profile manager;
generating a first command by combining the user description and the code profile;
transmitting the first command to an artificial intelligence (AI) proxy;
receiving the source code from the AI proxy; and
transmitting the source code to a user device.

16. The non-transitory computer-readable device of claim 15, wherein retrieving the code profile from the profile manager further comprises:
retrieving an identifier of the code profile from the information of the code profile, wherein the identifier of the code profile distinguishes the code profile from other code profiles in the profile manager;
transmitting a request for the code profile to the profile manager, wherein the request includes the identifier of the code profile; and
receiving the code profile from the profile manager.

17. The non-transitory computer-readable device of claim 15, wherein the code profile comprises:
one or more coding languages indications,
one or more existing source code sections,
one or more functions to be used in the source code, or
one or more illustration requirements.

18. The non-transitory computer-readable device of claim 15, wherein the code profile comprises domain knowledge and context of the source code.

19. The non-transitory computer-readable device of claim 18, wherein the operations further comprise extracting the context from a runtime environment.

20. The non-transitory computer-readable device of claim 15, wherein the operations further comprise:
receiving a feedback from the user device, wherein the feedback includes an updated user description;
generating a second command by combining the updated user description and the first command;
transmitting the second command to the AI proxy;
receiving an updated source code; and
transmitting the updated source code to the user device.
